(19) United States
(12) Patent Application Publication
(10) Pub. No.: US 2026/0286211 A1
(43) Pub. Date: Sep. 24, 2026

(54) COMPOSITION AND METHODS FOR INHIBITING CORROSION OF METAL DURING ACIDIZING A WELLBORE IN A SUBTERRANEAN FORMATION FOR FRACKING

(71) Applicant: Roy W. Martin, Naples, FL (US)

(72) Inventor: Roy W. Martin, Naples, FL (US)

(21) Appl. No.: 19/695,565

(22) Filed: Jun. 2, 2026

Related U.S. Application Data
(63) Continuation-in-part of application No. 19/412,927, filed on Dec. 9, 2025, now Pat. No. 12,692,428.
Application No. 19/412,927 is a continuation-in-part of application No. 19/382,658, filed on Nov. 7, 2025.
Application No. 19/382,658 is a continuation-in-part of application No. 19/258,959, filed on Jul. 3, 2025, now Pat. No. 12,497,554.
Application No. 19/258,959 is a continuation-in-part of application No. 19/208,667, filed on May 15, 2025.
Application No. 19/208,667 is a continuation-in-part of application No. 19/170,589, filed on Apr. 4, 2025, now Pat. No. 12,473,800.
(60) Provisional application No. 63/742,905, filed on Jan. 8, 2025.
(60) Provisional application No. 63/771,796, filed on Mar. 14, 2025.
(60) Provisional application No. 63/773,577, filed on Mar. 18, 2025.
(60) Provisional application No. 63/981,081, filed on Feb. 12, 2026.

(51) Int. Cl. C09K 8/54; C09K 8/74; E21B 43/119; E21B 43/27

(52) U.S. Cl. CPC C09K 8/54; C09K 8/74; E21B 43/119; E21B 43/27; C09K 2208/32

(57) ABSTRACT

An acid composition for acidizing a wellbore including an acid, an acetoxystyrene, and a polycyclic diquaternary quinoxaline. A method of using the acid composition. A method of forming a hydrocarbon-bearing formation for a stimulation operation including injecting the acidic composition into a wellbore so that the acidic composition is indirect contact with a perforation tool, a wireline and a wellbore casing, allowing the acidic composition to come into contact with a first perforated area and a first cementitious debris for a predetermined period of time to prepare the formation for a stimulation operation, and allowing the acidic composition to come into contact with a second perforated area and a second cementitious debris for a predetermined period of time to prepare the formation for the stimulation operation.

### FIELD OF THE INVENTION

The invention relates to compositions and methods for inhibiting corrosion of at least metal in a wellbore during acidizing a wellbore in a subterranean formation for fracking and extraction of oil. The metal can be for example a casing of the wellbore, a wireline, or a perforation tool.

### BACKGROUND OF THE INVENTION

Corrosion of metal surfaces of the casing of the wellbore, the wireline, or the perforation tool used for fracking caused by acids during acidizing of the wellbore are common problems. Furthermore, it is common practice to remove the perforation tool from the wellbore prior to acidizing of the wellbore to prevent corrosion of the metal surface of the perforation tool.

U.S. Patent Publication No. 20240279533 (McLoughlin) discloses compositions used to reduce corrosion of a casing of the wellbore, a wireline, or a perforation tool in the wellbore caused by acids during acidizing of the wellbore. The perforation tool can remain in the wellbore during the acidizing of the wellbore. The complete disclosure of this publication is incorporated herein by reference.

U.S. Application 20140116708A1 discloses a water-in-oil emulsion comprising from 50:50 to 80:20 v/v water phase to oil phase. The disclosure further recites addition of corrosion inhibitors including quaternary compounds, cinnamaldehyde, acetylenic alcohols, intensifiers, cuprous ions, and carboxylic acids (i.e. formic acid).

U.S. Pat. No. 10,822,535 discloses a synthetic acid comprising hydrochloric acid and monoethanol amine at a molar ratio of 15:1 to 3:1 respectively with the preferred molar ratio of 4.1:1 respectively. FIG. 1 of the said patent illustrates the dissolution rate of Indiana limestone comparing the preferred embodiment to 15% hydrochloric acid.

U.S. Pat. No. 7,586,013B2 discloses methods for preparing acetoxystyrene. The complete disclosure of this publication is incorporated herein by reference.

### SUMMARY OF THE INVENTION

A new class of corrosion inhibitor composition has been developed for inhibiting corrosion of multiple metallurgies encountered for acidizing a wellbore in a subterranean formation for fracking and extraction of hydrocarbons. The metal can be for example a stainless steel tanker for transporting the acid, a casing of the wellbore, a wireline, or a perforation tool. Furthermore, the corrosion inhibitor composition provides a streamline safe acid that is compatible with stainless steel tankers used to transport the acid to the point-of-use.

One preferred composition that has been assigned a new CAS Registry Number® (CAS RN): 3085265-95-5, and given the CA Index Name: Quinoxalinium, 1,4-bis(phenylmethyl)-, chloride (1:2).

The polycyclic diquaternary quinoxaline (PDQ) combined with acetoxystyrene compounds of the invention provide unexpectedly and surprisingly increased adhesion, protective film uniformity and reduced corrosion rates of multiple metallurgies. Furthermore, the synergistic effects of combining effective amounts of polycyclic diquaternary quinoxaline and acetoxystyrene with acid eliminates the need for traditional intensifiers like potassium iodide, formic acid and antimony trioxide to name a few.

Without being bound by theory, it is believed the acetoxystyrene chemically adsorbs to the metal surface thereby conditioning it by providing a film well suited for adsorption of the PDQ. The high charge density PDQ is attracted to the partial negative charged carbonyl groups distributed throughout the film. The PDQ's Gemini (twin) quaternary groups coupled with the geometric structure of the molecule improve the adhesion and uniform distribution of the hydrophobic film across the metal surfaces, thereby enhancing corrosion inhibition.

Quaternary surfactants exemplified by quaternary pyridinium and quaternary quinolinium are desirable corrosion inhibitors for acidizing compositions. Because the metal (i.e. carbon steel) surface in acid solutions are etched of oxide films, the surfaces take on a cationic charge due to the presence of iron. While chloride anions in hydrochloric acid impart a bridging anionic charge between the corrosion inhibitor and the steel surface, intensifiers are typically applied to transition the surface to an anionic charge thereby making it suitable for adsorption of the quaternary surfactant. Examples of suitable intensifiers include: iodide, iodate, bromide, formaldehyde, acetaldehyde, formic acid, antimony, stannous, bismuth and germanium.

Halide “Intensifiers” like bromide and iodide further increase the attraction of the quaternary corrosion inhibitor Cl<Br<I with iodide ions possessing higher atomic mass and lower electronegativity than bromide or chloride.

The addition of halides enhances the adsorption of the quaternary corrosion inhibitor. However, the halides function as a mediary between the metal (steel) surfaces and quaternary corrosion inhibitor. This relationship can be represented as Quat-Halide-Fe interactions with the halide being the mediary (bridging ion) that ties them together.

Furthermore, imperfections (interruptions) in coverage of the steel substrate resulting from the geometry of the quaternary hydrophobic structure expose the surface to the corrosive acid solution resulting in: corrosion, dissolution of iron ions and evolution of hydrogen gas. To combat the persistent deterioration and subsequent loss of integrity of the protective film, a residual (reservoir) of corrosion inhibitor can be utilized to reestablish the film.

In order to mitigate the inherent weaknesses and subsequent metal losses resulting from these limitations, a new novel corrosion inhibitor chemistry is required.

This novel invention improves corrosion inhibition of metal (steel) during acidizing of the wellbore increasing the life of the wireline and perforating gun, thereby allowing increased perforating cycles of said equipment. Furthermore, due to the corrosion inhibition of multiple metallurgies, the invention provides for the ability to transport the inhibited acid solution in stainless steel tankers, where existing inhibited acids require lined tankers which can compromise the logistics and increase transportation cost.

The novel corrosion inhibitor comprises polycyclic diquaternary quinoxaline (PDQ). Polycyclic describes the presence of two or more cyclic groups in the PDQ structure. The term polycyclic is not limited to the cyclic groups being bonded together as exemplified in the non-limiting examples naphthalene and anthracene. However, if desired the polycyclic structure can be bonded together as in the case where chloromethyl naphthalene is used in the synthesis of the PDQ.

Disclosed are novel compositions and methods for inhibiting corrosion of metal in a wellbore during acidizing a wellbore in a subterranean formation for fracking and extraction of oil and gas. The disclosed compositions exhibit unexpected and surprisingly superior corrosion inhibition of metal surfaces compared to the prior art corrosion inhibitor compositions and methods. Application of the disclosed invention provides surprising and unexpectedly significant economic and performance advantages over the prior art.

### BRIEF DESCRIPTION OF THE DRAWINGS

FIG. 1 illustrates a non-limiting flow chart of how the acidizing solution comprising the corrosion inhibitors of the present invention is applied to a wellbore in the presence of the perforating tool and wireline.

FIG. 2 illustrates a perforation at as first location and a perforation at a second location in the wellbore.

### OBJECTIVES

In some embodiments, a method of operating a wellbore includes placing a wireline including a perforating gun in a wellbore, the wellbore extending through an earth formation and including a casing extending through the earth formation, the wireline including zinc, discharging the perforating gun to form perforations through the casing and in the earth formation surrounding the casing proximate the at least one perforating gun, flowing a fracturing fluid including one or more proppants through the perforations and into the earth formation to open fractures in the earth formation with the one or more proppants, introducing a flushing fluid into the wellbore to displace the fracturing fluid, and flowing a corrosion inhibitor composition into the wellbore and through the perforations at least one of before the fracturing fluid, with the fracturing fluid, or with the flushing fluid. The corrosion inhibitor composition includes an acetoxystyrene, and a polycyclic diquaternary quinoxaline. The corrosion inhibitor composition may further comprise an alkenylphenone.

In some embodiments, a method for inhibiting corrosion of a component comprising zinc, copper, aluminum, nickel, chromium, iron alloys thereof, or a combination thereof in the presence of an acid includes providing an acid composition in contact with a surface of the component. The corrosion inhibitor composition includes an acetoxystyrene and a polycyclic diquaternary quinoxaline. The corrosion inhibitor composition may further comprise an alkenylphenone.

In some embodiments, a method for inhibiting corrosion of a component comprising one or more of zinc, copper, aluminum, nickel, or chromium, or alloys thereof includes contacting a surface of the component, with a corrosion inhibitor composition comprising an acetoxystyrene, a polycyclic diquaternary quinoxaline. The corrosion inhibitor composition includes about 0.25 to 2 moles of polycyclic diquaternary quinoxaline (PDQ) for every 1 mole of acetoxystyrene.

The corrosion inhibitor composition includes about 0.5 parts by weight to about 5.0 parts by weight of the polycyclic diquaternary quinoxaline for every about 1.0 part by weight of the acetoxystyrene. More preferred, the corrosion inhibitor composition includes about 0.5 parts by weight to about 2 parts by weight of the polycyclic diquaternary quinoxaline for every about 1.0 part by weight of the acetoxystyrene.

Certain embodiments of the present disclosure include a method for inhibiting corrosion of a component that includes zinc, copper, aluminum, or chromium, or alloys thereof, or a combination thereof, in the presence of an acid. The method includes providing an acid composition in contact with a surface of the component. The acid composition includes a corrosion inhibitor composition that includes an acetoxystyrene with the structure:

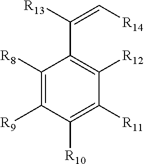

Wherein R₈, R₁₀, and R₁₂ are H, O(C═O)CH₃, or OCH₃;
R₉ and R₁₁ are H, OH, OCH₃ or linear or branched alkyl;
R₁₃ and R₁₄ are H, halo, or cyan; and
provided that at least one of R₈, R₁₀ or R₁₂ is O(C═O)CH₃.

Oligomers of polycyclic diquaternary quinoxaline have been assigned a new CAS Registry Number® (CAS RN): 3085536-05-3, and given the CA Index Name: Quinoxalinium, 1,4-bis(phenylmethyl)-, chloride (1:2) homopolymer.

The OCPs comprise oligomers and/or co-oligomers of the polycyclic diquaternary quinoxaline corrosion inhibitors. The number of carbon-carbon bonds (C—C) that link the polycyclic diquaternary quinoxaline (precursor used to make the OCP) can be controlled by regulating the molar ratio of nitrite to precursor as well as controlling the rate of nitrous acid production. For example, higher molar ratios of nitrite will support more coupling resulting in higher molecular weight OCPs. Furthermore, applying acid such as hydrochloric acid quickly induces localized high concentrations of nitrous acid, which in turn induces rapid coupling of the quaternary aromatic corrosion inhibitors as illustrated by the rapid, almost instantaneous color transition disclosed in some of the examples. It is presumed that these variables can expectedly influence the performance of the OCPs produced. Therefore, optimization of synthesis methods can be conducted to produce the desired performance of the OCPs with respect to corrosion inhibition.

### EMBODIMENTS

In the first embodiment is disclosed an acid composition for acidizing a wellbore, the composition comprising:
at least one acid; and a corrosion inhibitor composition, the corrosion inhibitor composition comprising:
an effective amount of polycyclic diquaternary quinoxaline having the general structure:

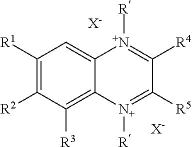

where X⁻ comprises a counter anion,
R′ comprises an alkyl aryl group, and
R¹, R², R³, R⁴ and R⁵ comprise hydrogen or a substitution group;

An effective amount of acetoxystyrene having the general structure:

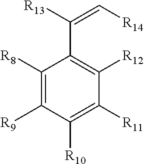

Wherein R₈, R₁₀, and R₁₂ are H, O(C═O)CH₃, or OCH₃;
R₉ and R₁₁ are H, OH, OCH₃ or linear or branched alkyl;
R₁₃ and R₁₄ are H, halo, or cyan; and
provided that at least one of R₈, R₁₀ or R₁₂ is O(C═O)CH₃.

The acid composition according to the first embodiment, wherein the acetoxystyrene is selected from at least one of 4-acetoxystyrene, 3-methoxy-4-acetoxystyrene, 3,5-dimethoxy-4-acetoxystyrene, 3,4-diacetoxystyrene, 2-acetoxystyrene, and a-cyano-4-acetoxystyrene.

The corrosion inhibitor composition according to the first embodiment, wherein the composition comprises from about 0.25 to 2 moles of polycyclic diquaternary quinoxaline (PDQ) for every 1 mole of acetoxystyrene.

The corrosion inhibitor composition according to the first embodiment, wherein the composition comprises from about 0.5 parts by weight to about 5.0 parts by weight of the polycyclic diquaternary quinoxaline for every about 1.0 part by weight of the acetoxystyrene.

The polycyclic diquaternary quinoxaline in accordance with the first embodiment, wherein the alkyl aryl group is selected from at least one of benzyl, benzoyl, vinylbenzyl and methyl naphthalene.

The polycyclic diquaternary quinoxaline in accordance with the first embodiment, wherein R¹, R², R³, R⁴ and R⁵ comprise substitution groups selected from: halo, alkyl, aryl and alkyl aryl.

The polycyclic diquaternary quinoxaline according to the first embodiment, wherein the counter anion is selected from at least one of chloride, bromide, iodide.

The polycyclic diquaternary quinoxaline in according with the first embodiment, wherein the counter anion is iodide.

The corrosion inhibitor composition in accordance with the first embodiment, wherein the polycyclic diquaternary quinoxaline comprises dibenzyl diquaternary quinoxaline having the general structure:

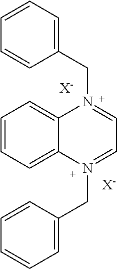

Where X⁻ comprises a counter anion.

The polycyclic diquaternary quinoxaline according to the first embodiment, wherein the polycyclic diquaternary quinoxaline is the result of:
combining and mixing in a vessel a solvent, quinoxaline and a supra-stoichiometric amount of cyclic halide;
the reaction between the quinoxaline and cyclic halide results in the formation of the polycyclic diquaternary quinoxaline, and
wherein the supra-stoichiometric amount of cyclic halide is greater than a 1.2:1 molar ratio of cyclic halide to quinoxaline.

In the second embodiment is disclosed an acid composition for acidizing a wellbore, the composition comprising:
at least one acid; an effective amount of an acetoxystyrene, and and an effective amount of quaternary quinoline;
the quaternary quinoline having the general structure:

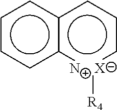

where X⁻ comprises a halide counter anion,
R₄ comprises an unsubstituted or an inertly substituted alkyl having 4 carbon atoms to 16 carbon atoms, or an unsubstituted or inertly substituted alkyl aryl having 7 carbon atoms to 20 carbon atoms.

The acid composition according to the second embodiment, wherein the acetoxystyrene having the general structure:

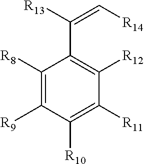

Wherein R₈, R₁₀, and R₁₂ are H, O(C═O)CH₃, or OCH₃;
R₉ and R₁₁ are H, OH, OCH₃ or linear or branched alkyl;
R₁₃ and R₁₄ are H, halo, or cyan; and
provided that at least one of R₈, R₁₀ or R₁₂ is O(C═O)CH₃.

The acid composition according to the second embodiment, wherein the acetoxystyrene is selected from at least one of 4-acetoxystyrene, 3-methoxy-4-acetoxystyrene, 3,5-dimethoxy-4-acetoxystyrene, 3,4-diacetoxystyrene, 2-acetoxystyrene, and a-cyano-4-acetoxystyrene.

The corrosion inhibitor composition according to the second embodiment, wherein the composition comprises from about 0.25 to 2 moles of quaternary quinoline for every 1 mole of acetoxystyrene.

The corrosion inhibitor composition according to the second embodiment, wherein the composition comprises from about 0.5 parts by weight to about 5.0 parts by weight of the quaternary quinoline for every about 1.0 part by weight of the acetoxystyrene. More preferred, the corrosion inhibitor composition includes about 0.5 parts by weight to about 2 parts by weight of the quaternary quinoline for every about 1.0 part by weight of the acetoxystyrene.

The corrosion inhibitor composition according to the second embodiment, further comprising and intensifier selected from at least one of an iodide donor, an aldehyde and formic acid.

The corrosion inhibitor composition according to the second embodiment, wherein the counter anion is selected from at least one of chloride, bromide and iodide.

The corrosion inhibitor composition according to the second embodiment, wherein the counter anion comprises iodide.

The corrosion inhibitor composition according to the second embodiment, further comprising an intensifier selected from at least one of a bromide donor, formaldehyde, antimony donor, bismuth donor, germanium donor, stannous donor and glyoxal.

The corrosion inhibitor composition in accordance with the second embodiment, further comprising a surfactant.

The corrosion inhibitor composition in accordance with the second embodiment, wherein the surfactant is selected from at least one of a nonionic surfactant, amphoteric surfactant and anionic surfactant.

The composition in accordance with the second embodiment, wherein the acid comprises about 15 wt % HCl.

The composition according to the second embodiment, wherein the acid comprises about 5 wt % to 28 wt %.

The composition in accordance with the second embodiment, wherein the quaternary quinoline ranges from about 250 ppm to 10000 ppm.

The composition in accordance with the second embodiment, wherein the composition is diluted with water at the point-of-use to achieve a ratio of composition and water of 1:1 respectively.

The composition in accordance with the second embodiment, wherein the composition is diluted with water at the point-of-use to achieve a ratio of composition and water of 1:2 respectively.

The composition in accordance with the second embodiment, wherein the surfactant comprises a nonionic surfactant.

The composition in accordance with the second embodiment, wherein the surfactant comprises an anionic surfactant.

The composition in accordance with the second embodiment, wherein the anionic surfactant is selected from at least one of an alkyl ether sulfates, alkyl sulfates, alkyl sulfonates, alkyl benzene sulfonates, alkyldiphenyloxide disulfonate and phosphate ester.

The composition in accordance with the second embodiment, wherein the anionic surfactant comprises a phosphate ester having from 3 to 20 moles of EO (ethylene oxide).

The composition in accordance with the second embodiment, wherein the acid comprises a synthetic acid.

In the third embodiment is disclosed:
a method of forming a hydrocarbon-bearing formation for a stimulation operation, the method comprising the steps:
assessing at least a first location and a second location for perforation of a casing in a wellbore;
inserting a bottom hole assembly into the well-bore;
the bottom hole assembly comprising a plug and a perforation tool and the bottom hole assembly being connected to a wireline;
injecting an acidic composition into the wellbore;
wherein the acidic composition is in direct contact with the perforation tool, the wireline and the casing;
positioning and setting the plug in the wellbore at a position downhole but proximate to the first location;
positioning the perforation tool at the first location;
perforating the casing at the first location with the perforation tool thereby creating a first perforated area and a first cementitious debris;
allowing the acidic composition to come into contact with the first perforated area and the first cementitious debris for a predetermined period of time to prepare the formation for the stimulation operation;
moving the perforation tool up-hole to the second location;
perforating the casing at the second location with the perforation tool thereby creating a second perforated area and a second cementitious debris;
allowing the acidic composition to come into contact with the second perforated area and the second cementitious debris for a predetermined period of time to prepare the formation for the stimulation operation;
removing the perforation tool from the wellbore; wherein the acid composition comprises an acid and a corrosion inhibitor composition, the corrosion inhibitor composition comprising:
an effective amount of an acetoxystyrene, and
an effective amount of polycyclic diquaternary quinoxaline;
the polycyclic diquaternary quinoxaline having the general structure:

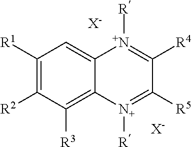

where X⁻ comprises a counter anion,
R′ comprises an alkyl aryl group, and
R¹, R², R³, R⁴ and R⁵ comprise hydrogen or a substitution group.

The corrosion inhibitor composition according to the third embodiment, wherein the acetoxystyrene having the general structure:

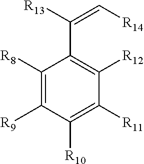

Wherein R₈, R₁₀, and R₁₂ are H, O(C═O)CH₃, or OCH₃;
R₉ and R₁₁ are H, OH, OCH₃ or linear or branched alkyl;
R₁₃ and R₁₄ are H, halo, or cyan; and
provided that at least one of R₈, R₁₀ or R₁₂ is O(C═O)CH₃.

The acid composition according to the third embodiment, wherein the acetoxystyrene is selected from at least one of 4-acetoxystyrene, 3-methoxy-4-acetoxystyrene, 3,5-dimethoxy-4-acetoxystyrene, 3,4-diacetoxystyrene, 2-acetoxystyrene, and a-cyano-4-acetoxystyrene.

The corrosion inhibitor composition according to the third embodiment, wherein the corrosion inhibitor composition inhibits corrosion of zinc, copper, aluminum, nickel, chromium, iron alloys thereof, or a combination thereof, in the presence of an acid.

The corrosion inhibitor composition according to the third embodiment, wherein the corrosion inhibitor composition inhibits corrosion of at least one of the wireline and perforating tool.

The corrosion inhibitor composition according to the third embodiment, wherein the alkyl aryl group is selected from at least one of benzyl, benzoyl, vinylbenzyl and methyl naphthalene.

The corrosion inhibitor composition according to the third embodiment, wherein R¹, R², R³, R⁴ and R⁵ comprise substitution groups selected from: halo, alkyl, aryl and alkyl aryl.

The corrosion inhibitor composition according to the third embodiment, wherein the counter anion is selected from at least one of chloride, bromide and iodide.

The corrosion inhibitor composition according to the third embodiment, wherein the counter anion comprises iodide.

The corrosion inhibitor composition according to the third embodiment, further comprising an intensifier selected from at least one of an iodide donor, bromide donor, formaldehyde, formic acid, antimony donor, bismuth donor, germanium donor, stannous donor and glyoxal.

The corrosion inhibitor composition in accordance with the third embodiment, wherein the polycyclic diquaternary quinoxaline comprises dibenzyl diquaternary quinoxaline having the general structure:

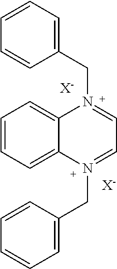

Where X⁻ comprises a counter anion.

The corrosion inhibitor composition in accordance with the third embodiment, further comprising a surfactant.

The corrosion inhibitor composition in accordance with the third embodiment, further comprising a surfactant selected from at least one of a nonionic surfactant, amphoteric surfactant and anionic surfactant.

The corrosion inhibitor composition according to the third embodiment, further comprising a surfactant selected from an ethoxylate alcohols having 16 to 18 carbon alkyl chain.

The corrosion inhibitor composition in accordance with the third embodiment, wherein the acid comprises about 15 wt % HCl.

The corrosion inhibitor composition in accordance with the third embodiment, wherein the polycyclic diquaternary quinoxaline ranges from about 250 ppm to 10000 ppm.

The corrosion inhibitor composition in accordance with the third embodiment, wherein the composition is diluted with water at the point-of-use to achieve a ratio of composition and water of 1:1 respectively.

The corrosion inhibitor composition in accordance with the third embodiment, wherein the composition is diluted with water at the point-of-use to achieve a ratio of composition and water of 1:2 respectively.

The corrosion inhibitor composition in accordance with the third embodiment, wherein the acid comprises a synthetic acid.

In the fourth embodiment is disclosed:
a method of forming a hydrocarbon-bearing formation for a stimulation operation, the method comprising the steps:
assessing at least a first location and a second location for perforation of a casing in a wellbore;
inserting a bottom hole assembly into the well-bore;
the bottom hole assembly comprising a plug and a perforation tool and the bottom hole assembly being connected to a wireline;
injecting an acidic composition into the wellbore;
wherein the acidic composition is in direct contact with the perforation tool, the wireline and the casing;
positioning and setting the plug in the wellbore at a position downhole but proximate to the first location;
positioning the perforation tool at the first location;
perforating the casing at the first location with the perforation tool thereby creating a first perforated area and a first cementitious debris;
allowing the acidic composition to come into contact with the first perforated area and the first cementitious debris for a predetermined period of time to prepare the formation for the stimulation operation;
moving the perforation tool up-hole to the second location;
perforating the casing at the second location with the perforation tool thereby creating a second perforated area and a second cementitious debris;
allowing the acidic composition to come into contact with the second perforated area and the second cementitious debris for a predetermined period of time to prepare the formation for the stimulation operation;
removing the perforation tool from the wellbore; wherein the acid composition comprises an acid and a corrosion inhibitor composition, the corrosion inhibitor composition comprising:
an effective amount of an acetoxystyrene, and
an effective amount of quaternary quinoline;
the quaternary quinoline having the general structure:

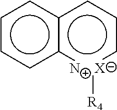

where X⁻ comprises a halide counter anion,
R₄ comprises an unsubstituted or an inertly substituted alkyl having 4 carbon atoms to 16 carbon atoms, or an unsubstituted or inertly substituted alkyl aryl having 7 carbon atoms to 20 carbon atoms.

The corrosion inhibitor composition according to the fourth embodiment, wherein the acetoxystyrene having the general structure:

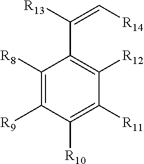

Wherein R₈, R₁₀, and R₁₂ are H, O(C═O)CH₃, or OCH₃;
R₉ and R₁₁ are H, OH, OCH₃ or linear or branched alkyl;
R₁₃ and R₁₄ are H, halo, or cyan; and
provided that at least one of R₈, R₁₀ or R₁₂ is O(C═O)CH₃.

The acid composition according to the fourth embodiment, wherein the acetoxystyrene is selected from at least one of 4-acetoxystyrene, 3-methoxy-4-acetoxystyrene, 3,5-dimethoxy-4-acetoxystyrene, 3,4-diacetoxystyrene, 2-acetoxystyrene, and a-cyano-4-acetoxystyrene.

The corrosion inhibitor composition according to the fourth embodiment, wherein the corrosion inhibitor composition inhibits corrosion of zinc, copper, aluminum, nickel, chromium, iron alloys thereof, or a combination thereof, in the presence of an acid.

The corrosion inhibitor composition according to the fourth embodiment, wherein the corrosion inhibitor composition inhibits corrosion of at least one of the wireline and perforating tool.

### DETAILED DESCRIPTION OF THE INVENTION

The following terms will be used throughout the specification and will have the following meanings unless otherwise indicated.

“A” or “an” means “at least one” or “one or more” unless otherwise indicated.

“Comprise”, “have”, “include” and “contain” (and their variants) are open-ended linking verbs and allow the addition of other elements when used in a claim. “Consisting of” is closed, and excludes all additional elements.

“Consisting essentially of” excludes additional material elements, but allows the inclusions of non-material elements that do not substantially change the nature of the invention.

When referring to a group, “at least one . . . and . . . ” in the specification and claims is synonymous with “and/or”. For example, “at least one of A, B and C” means A alone, B alone, C alone, or any combination of A, B or C.

“wt. %” is based on the total weight of the composition unless otherwise stated.

### Definitions

Various compositions and methods of the invention are described below. Although particular compositions and methods are exemplified herein, it is understood that any of a number of alternative compositions and methods are applicable and suitable for use in practicing the invention.

As used herein, “ambient temperature” is used to describe the ability to carry out the oxidative coupling reaction without applying heat energy to elevate the temperature. Ambient temperature comprising typical room temperature (68-76° F.) allows the reaction to proceed. Reference to ambient temperature is not used to limit the range of temperature, it is only used to highlight the ability to carry out the oxidative coupling reaction without applying heat.

As used herein, “wellbore” describes the drilled channel (hole) within a subterranean formation that is lined with a metal casing (pipe). An example of a wellbore is shown in FIG. 2.

As used herein, “oxidative coupling product” also referred to as “OCP” and/or “OCPs” describes the product produced from an oxidative coupling reaction that results in a condensation product between two or more molecules of quaternary corrosion inhibitors selected from at least one of quaternary pyridinium and quaternary quinolinium and their various combinations (molar or wt % ratios). The said pyridinium and quinolinium may further comprise alkyl and/or aryl derivatives. The oxidative coupling product comprises at least one quaternary function group but preferably comprise two or more quaternary functional groups. Furthermore, when higher molar ratios of nitrite donor are applied during the production of OCPs, additional linking between the reactants occur resulting in an OCP comprising more than two bonded (linked) oxidative coupling reactants. For example, an OCP comprising a quaternary pyridinium-quinolinium complex may undergo additional oxidative coupling to produce a quaternary pyridinium-quinolinium-pyridinium complex. These higher molecular weight OCPs can form a tar like precipitate that is readily dissolved in an appropriate solvent system such as glycol ethers.

As used herein, “oxidative coupling reaction” describes the mechanism that chemically bonds (couples) two or more molecules of quaternary aromatic corrosion inhibitors selected from at least one of quaternary quinolinium and quaternary pyridinium resulting in the production of a corrosion inhibiting oxidative coupling product comprising at least one of an oligomer and co-oligomer or said quaternary aromatic corrosion inhibitors. Without being bound by theory, the oxidative coupling product is believed to be the condensation product of the quaternary corrosion inhibitors resulting from oxidative coupling initiated by the decomposition products of nitrous acid exemplified by free radical nitric oxide (NO·), nitrosonium (NO⁺) and the like.

As used herein “acid composition” and “acidizing composition” can be used interchangeably.

As used herein, “metal” is used to describe carbon steel, carbon steel alloys and stainless steel that comes in contact with the aqueous acidizing composition during the acidizing of the wellbore in fracking operation. Examples of such metallic surfaces include the steel casing lining the wellbore, the wireline and the perforating gun.

As used herein, “gpt” means gallons per thousand, and specifically pertains to the dosage of corrosion inhibiting composition (gallons) added per 1000 gallons of aqueous acidizing composition.

As used herein, “iodide donor” describes a compound that comprises an iodide atom. Non-limiting examples of iodide donors include: sodium iodide, potassium iodide, ammonium iodide, cupper iodide, iodine and iodate salts.

As used herein, “bromide donor” describes at source of bromide exemplified by the non-limiting examples: sodium bromide, potassium bromide, lithium bromide, ammonium bromide and the like.

As used herein, “effective amount” describes the concentration of a chemical to achieve the target effect. Non-limiting examples include: an effective amount of polycyclic diquaternary quinoxaline is the amount needed to achieve an acceptable (targeted) corrosion rate; an effective amount of nitrous acid is the concentration required to produce the target amount of oxidative coupling product; an effective amount of oxidative coupling product is the concentration required to achieve an acceptable (targeted) corrosion rate, and the like.

As used herein, “point-of-use” describes the location at which the acidizing composition is applied to the wellbore. The point-of-use is the location where the concentrated composition for acidizing a wellbore is diluted with water at a ratio from about 1:1 to 1:2 acidizing composition to water respectively thereby reducing the freight, storage and chemical cost of acidizing the wellbore.

As used herein, “water” having the chemical formula H₂O may comprise various concentrations of mineral salts (e.g. brine, produced water) and other additives and contaminants that are dissolved or dispersed in the water resulting in an aqueous solution.

As used herein, “cyclic halide” is a halogenated (Cl, Br, I) alkyl aryl compound that adds a cyclic group during the quaternization of the amine group. Nonlimiting examples of cyclic halides include: benzyl chloride, benzyl bromide, benzyl iodide, benzoyl chloride and chloromethyl naphthalene.

### Acids

Suitable acid can be selected from synthetic acids, mineral acids, organic acids and/or any combination thereof, to be for example the acid is at least one mineral acid. Examples of the acid concentration in the aqueous acidizing composition range between about 5 to 28 wt %, more preferably about 7.5 to 20 wt % and most preferably about 10 to 15 wt %. Suitable acid can be selected from mineral acids, organic acids and/or any combination thereof. Non-limiting examples of mineral acids include hydrochloric acid, sulfuric acid, hydrofluoric acid, nitric acid and the like.

Acids may further comprise synthetic acids which are mineral acid (i.e. hydrochloric acid) stabilized using retarding agents. Non-limiting examples of organic acids include formic acid, acetic acid, citric acid, lactic acid and the like.

Retarding agents are organic nitrogen bearing compounds that form adducts with the acid to slow the release of the hydrogen and retard the aggressive corrosive nature of the acid. For example, urea combined with hydrochloric acid forms urea hydrochloride which dramatically retards the reactivity of the acid solution and suppresses the toxic vapors. Numerous retarding agents have been disclosed in the prior art including amino acids (e.g. glycine, lysine etc.), amino alcohols (e.g. monoethanolamine, diethanolamine etc.) and amines such as morpholine and dieethylhydroxlamine. These are non-limiting examples and the limited examples is not intended to limit the viable retarding agents available. Prior art can be referenced for a more comprehensive list of available retarding agents.

Preferred retarding agents are thermally stable nitrogen bearing compounds that can handle greater than 150° C. in and aqueous solution without undergoing thermal decomposition. Non-limiting examples of thermally stable nitrogen bearing compounds include glycine, aspartate, asparagine, cysteine, glutamate, glutamine, arginine, histidine and hydrazine. The thermally stable nitrogen bearing compounds can be combined with hydrochloric acid to produce adducts that reduce the aggressive corrosion of the hydrochloric acid thereby extending the life of the synthetic acid when applied to the wellbore and reducing the potential damage to the formation near the wellbore. Limestone testing demonstrates the dramatic reduction in the dissolution of limestone especially when the synthetic acid is combined with the OCPs disclosed.

The molar ratio of thermally stable nitrogen bearing compounds to hydrochloric acid range from 1:8 to 1:1, more preferred 1:6 to 1:1.5 and most preferred 1:4 to 1:2 respectively.

Surfactants comprise molecules that can form micelles and are preferably nonionic, anionic and amphoteric. Cationic surfactants could be used sparingly but it has been found higher concentrations interfere with the cationic charged corrosion inhibitor reducing corrosion inhibitor performance.

Nonionic surfactants are preferably ethoxylated alcohols.

Anionic surfactants are selected from at least one of an alkyl ether sulfates, alkyl sulfates, alkyl sulfonates, alkyl benzene sulfonates, alkyldiphenyloxide disulfonate and phosphate esters. Phosphate esters preferably have greater than or equal to 3 moles of ethylene oxide (EO), more preferred greater than or equal to 6 moles of EO and most preferred greater than or equal to 9 moles of EO. To enhance the dispersion of the polycyclic diquaternary quinoxaline in the acidizing solution, one preferred phosphate ester comprises phosphate polyarylphenol ethoxylate available from Stepan chemical company and sold under the tradename Stepfac TSP-PE K. Effective surfactants for the acetoxystyrene include phosphate esters having from 3-6 moles of ethoxylate, available from Stepan chemical company and sold under the tradename Stepfac 8180 and 8181.

Acetoxystyrene having the general structure:

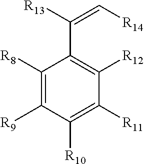

Wherein R₈, R₁₀, and R₁₂ are H, O(C═O)CH₃, or OCH₃;
R₉ and R₁₁ are H, OH, OCH₃ or linear or branched alkyl;
R₁₃ and R₁₄ are H, halo, or cyan; and
provided that at least one of R₈, R₁₀ or R₁₂ is O(C═O)CH₃.

Non-limiting examples of acetoxystyrene having this structure include: 4-acetoxystyrene, 3-methoxy-4-acetoxystyrene, 3,5-dimethoxy-4-acetoxystyrene, 3,4-diacetoxystyrene, 2-acetoxystyrene, and a-cyano-4-acetoxystyrene.

One preferred of acetoxystyrene comprises 4-acetoxystyrene having the general structure:

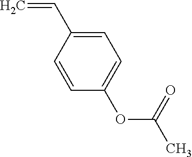

### Synthesis of Polycyclic Diquaternary Quinoxaline

Polycyclic Diquaternary Quinoxaline can be produced using commercially available reagents. O-phenylenediamine and its various derivatives can be reacted with dicarbonyl compounds such as glyoxal to produce the quinoxaline. Non-limiting examples of dicarbonyl compounds include glyoxal, phthalaldehyde and benzyl. Preferably the polycyclic diquaternary quinoxaline is produced by reacting the cyclic halide with quinoxaline in alcohol as the solvent. Preferably the alcohol is methanol.

Various solvents exemplified by the non-limiting examples include methanol, ethanol, water-alcohol, ethyl acetate, chloroform and acetonitrile to name a few. A 1:1 molar ratio of reactants is combined and mixed to produce a solution of quinoxaline. To the solution of quinoxaline, a supra-stoichiometric amount of cyclic halide (e.g. benzyl chloride, benzoyl chloride, chloromethyl naphthalene) is added and mixed. An optional catalyst such as iodide and/or heating (≥60° C.) accelerates the reaction resulting in the production of the polycyclic diquaternary quinoxaline.

A supra-stoichiometric amount of cyclic halide is added to provide greater than a 1.2:1 molar ratio of cyclic halide to quinoxaline respectively. Preferably, the supra-stoichiometric amount of cyclic halide is greater than or equal to a 2:1 ratio of cyclic halide to quinoxaline respectively.

### Methods

The description that follows, and the embodiments described therein, is provided by way of illustration of an example, or examples, of particular embodiments of the principles of the present invention. These examples are provided for the purposes of explanation, and not limitation, of those principles and of the invention.

In a conventional plug and perforate operations, the isolation plug is set in the well, the casing is perforated by a tool (guns), then the tool is pulled out of the hole and then acid is pumped and circulated to the perforations (this process can take hours in some extreme cases) and once a feed rate is reached, they begin the stimulation for that stage of the well. The process is then repeated (over 40 to 100 or more stages in many cases).

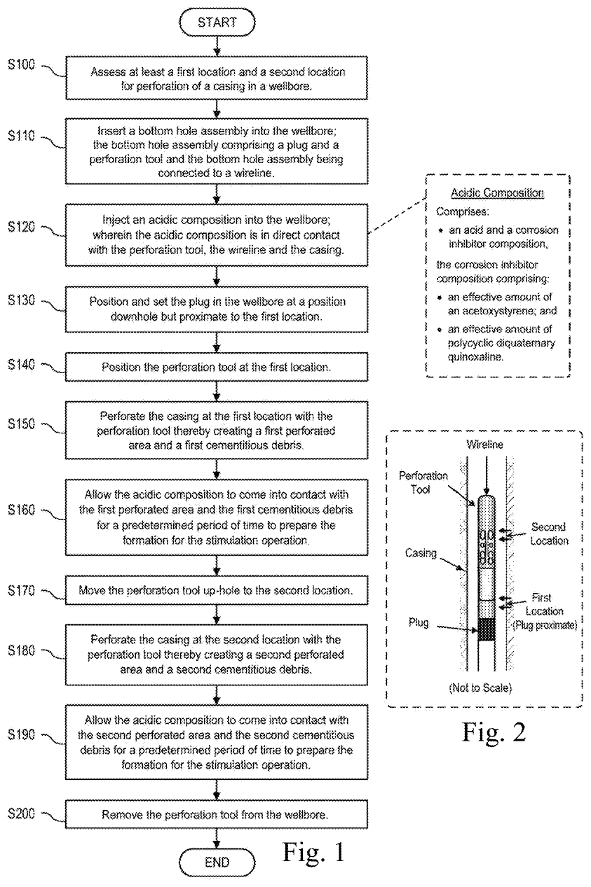

According to a preferred embodiment of the present invention, the method allows for an operator to pump the tools down with the spearhead acid to perforate the zone and let the acid sit over the perforations or perforate in the acid. This is followed by the removal of the tool from the wellbore and initiating of the stimulation immediately following the perforating tools removal, thereby greatly increasing the efficiency of the operation by removing an entire step from the common process. An example of a method according to the present invention is shown in the flow chart of FIG. 1.

According to a preferred embodiment of the present invention, this method can save up to one (1) hour per stage at an average cost of $20,000/hr (for the stimulation crew and equipment) and 30-50 m³ (8000-13,250 gallons) of water per stage depending on depth, casing size and final method. In an average 50-stage well, this can translate into savings of up to or over $1,000,000 in time plus the saved water of up to or over 800,000 gallons. The potential savings from the implementation of this method in operations in the North America alone could reach upwards of several hundreds of millions of dollars per year for the industry and billions of gallons of water saved.

Hydrochloric acid (HCl) is the most commonly used acid in stimulation or for spearhead acid. With this in mind, one must understand that perforation tools and the deployment wireline systems are mostly comprised of stainless metal to ensure longevity and offer the highest level or performance. Conventional plug and perforation processes require the removal of the perforation guns immediately after the perforation stage otherwise the spearhead acid could compromise the perforating guns and deployment wireline systems because of their propensity to attack stainless-metal and stainless-metal alloys. A critical factor in allowing a process to have stainless metal predominate components exposed to strong acids such as HCl is the ability to control or minimize corrosion to a level below which would normally render a stainless-metal tool and wireline deployment system unusable after only a few cycles (or even less in some cases). With the development of a novel corrosion inhibitor which affords substantial long-term acidic exposure protection of stainless metal or such acid sensitive alloys from damage from exposure to hydrochloric acid (HCl), there is a never-seen-before industrial or industry-wide scale possibility of removing a time and water consuming step of the pre-stimulation process, thereby saving substantial time, money and water resources. The advantages are compounded when using optimal acidic compositions (i.e. effectiveness and corrosion inhibition) as more wells and more perforation operations can be carried out. The savings are compounded by the number of operations which are carried out without replacing the bottom hole assembly and/or the wireline/slickline or coiled tubing or applicable conveyance method. For this reason, a new generation of corrosion inhibitor for use during acidizing a wellbore is needed.

The compositions and methods disclosed provide superior corrosion inhibition and well as significantly improved economics when compared to the corrosion inhibitors disclosed in the prior art.

### Synthesis of Polycyclic Diquaternary Quinoxaline

The following examples are methods used to produce Quinoxalinium, 1,4-bis(phenylmethyl)-, chloride (1:2).

### Example 1

A ceramic dish containing water and a layer of silicone oil was placed on a stirring hot plate. A 420 ml glass pressure vessel was placed into the water bath and secured. A stirring rod was inserted and 100 ml of ethanol was added followed by 20.0 g of O-phenylenediamine. While mixing 21.15 ml of 40% glyoxal was added. The solution turned amber in color as the diamine dissolved producing the quinoxaline solution. The solution was allowed to stir and react for 30 minutes, then 42.5 ml (46.83 g) of benzyl chloride was added. The pressure vessel was sealed and the hot plate was set to 100° C. which brought the temperature of the water bath to 70° C. The solution was allowed to react at temperature for about 5 hrs, then the heat was turned off allowing the blue-black solution to mix and cool overnight. 170.69 g of polycyclic diquaternary quinoxaline was recovered. The density was determined to be 1.01 g/ml. The sample was labeled Gemini 2:1 reflecting the molar ratio of benzyl chloride to quinoxaline.

### Coupon Testing

C1010 carbon steel coupons were used for the initial testing. Acidizing samples were prepared using 15 wt % HCl and treated with the appropriate corrosion inhibitors and intensifiers as disclosed resulting in beakers containing approximately 190 ml of acidizing solution. The samples were placed in a water bath, the water coated with a layer of silicone oil to retain heat. A thermometer in a sealed water filled jar was used to monitor the liquid temperature in the samples. A digital heater was set at 300° C. to begin heating the samples. Once the sample temperatures reached 90° C., the coupons were inserted to the beakers and covered. The heater was reduced to 210° C. which sustained 98-100° C. consistently throughout the duration of the test. The test duration of 4 hours began when the sample temperature exceeded 90° C.

TABLE 1

| | 1V | 2V |
|---|---|---|
| Stock 15% HCl | 185 ml | 185 ml |
| Gemini-2:1 | 4.0 ml | 4.0 ml |
| KI | 0.65 ml | 1.3 ml |
| Start Wt | 12.22 | 12.11 |
| End Wt | 12.01 | 11.91 |
| Delta Wt | 0.21 | 0.2 |
| wt % | 1.72% | 1.65% |
| Metal loss (lbm/ft₂) | 0.02 | 0.02 |

The coupons were retrieved exposing a bright bluish-green solution in the beakers which is extremely uncharacteristic. The metal loss was well below the NACE SP21469-2021 standard of 0.05 lbm/ft².

Another series of coupon test were conducted using different intensifiers for comparison following the same testing protocol and duration.

TABLE 2

| | 1W | 2W | 3W | 4W | 5W |
|---|---|---|---|---|---|
| Stock 15% HCl | 185 ml | 185 ml | 185 ml | 185 ml | 185 ml |
| Gemini 2:1 | 4.0 ml | 4.0 ml | 4.0 ml | 4.0 ml | 4.0 ml |
| KI | 0.65 ml | 0.65 ml | NA | NA | NA |
| Formaldehyde | 0.6 ml | NA | NA | NA | NA |
| Formic Acid | NA | 0.5 ml | NA | 0.5 ml | NA |
| H2O2 | NA | NA | NA | NA | 3.5 ml |
| Start Wt | 12.22 | 12.28 | 12.21 | 12.34 | 12.25 |
| End Wt | 11.94 | 12.08 | 11.89 | 12.04 | 11.90 |
| Delta Wt | 0.28 | 0.20 | 0.32 | 0.30 | 0.35 |
| wt % | 2.29% | 1.63% | 2.62% | 2.43% | 2.86% |

The coupons were retrieved exposing a bright bluish-green solution in the beakers. After washing the coupons in EB Solvent followed by methanol, coupon 1W retained a black uniform film across the entire surface. All of the coupons were very smooth indicating no obvious pitting. It appeared the coupons had undergone an initial period of corrosion, followed by the establishment of a uniform protective film. Furthermore, while sample 3W did not comprise an additional initiator, its performance was comparable to the remaining samples that included initiators. Without being bound by theory, the high charge density resulting from the diquaternary functionality compensated for the lack of supporting initiator.

C1010 carbon steel coupon testing was repeated using the same testing protocol, however the duration of the test was extended to 8 hours.

TABLE 3

| | 1X | 2X | 3X | 4X |
|---|---|---|---|---|
| Stock 15% HCl | 185 ml | 185 ml | 185 ml | 185 ml |
| Gemini 2:1 | 4.0 ml | 4.0 ml | 4.0 ml | 4.0 ml |
| KI | 0.65 ml | 0.65 ml | 0.65 ml | 0.65 ml |
| Formaldehyde | 0.6 ml | NA | NA | NA |
| Formic Acid | NA | 0.5 ml | 2.0 ml | NA |
| Start Wt | 12.22 | 12.23 | 12.26 | 12.15 |
| End Wt | 12.03 | 12.04 | 12.07 | 11.91 |
| Delta Wt | 0.19 | 0.19 | 0.19 | 0.24 |
| wt % | 1.56% | 1.59% | 1.56% | 1.98% |

The results of the 8 hour testing illustrate that once the protective film is established, further corrosion is inhibited.

### Example 2

A new batch of polycyclic diquaternary quinoxaline was produced using a 1.95:1 molar ratio of benzyl chloride to tertiary amine content in the quinoxaline. This approach allowed a slight residual of tertiary amine to remain unreacted, thereby driving the reactions toward the depletion of benzyl chloride. Furthermore, the temperature was increased and the duration of the reaction was extended to 24 hours.

A ceramic dish containing water and a layer of silicone oil was placed on a stirring hot plate. A 420 ml glass pressure vessel was placed into the water bath and secured. A stirring rod was inserted and 150 ml of methanol was added followed by 30.0 g of O-phenylenediamine. While mixing 31.73 ml of 40% glyoxal was added. The solution turned amber in color as the diamine dissolved producing the quinoxaline solution. The solution was allowed to stir and react for 20 minutes, then 62.27 ml (68.5 g) of benzyl chloride was added. The pressure vessel was sealed and the hot plate was set to 125° C. which brought the temperature of the water bath to 74° C. The solution was allowed to react at temperature for about 24 hrs, then the heat was turned off allowing the black solution to mix and cool overnight. 257.29 g of polycyclic diquaternary quinoxaline was recovered. The sample was labeled Gemini 1.95:1 reflecting the molar ratio of benzyl chloride to quinoxaline.

### Coupon Test

C1010 carbon steel coupon testing was repeated using the same testing protocol using a water bath having a silicone oil layer to suppress evaporation and sustain temperature at 100° C. The test duration was 8 hours.

TABLE 4

| | | |
|---|---|---|
| Stock 15% HCl | 185 ml | 185 ml |
| Gemini 1.95:1 | 4.0 ml | 4.0 ml |
| KI | 0.65 ml | 6.65 ml |
| | (~390 ppm I⁻) | (1:1 I⁻:N⁺) |
| Start Wt | 12.20 g | 12.28 g |
| End Wt | 12.00 g | 12.22 g |
| Delta Wt | 0.20 g | 0.06 g |
| wt % | 1.64% | 0.49% |
| Metal Loss | 0.019 lbm/ft² | 0.006 lbm/ft² |

Two different iodide concentrations were tested to determine the effect on corrosion rate. Surprisingly the high iodide concentrations that achieved a 1:1 molar ratio of Iodide to quaternary group dramatically reduced the corrosion rate.

Another series of 8 hr test were conducted using 1:1 molar iodide:quaternary group with different concentrations of Gemini 1.95:1.

TABLE 5

| | | | |
|---|---|---|---|
| Stock 15% HCl | 185 ml | 185 ml | 185 ml |
| Gemini 1.95:1 | 2.0 ml | 3.0 ml | 4.0 ml |
| KI (15% KI) | 3.35 ml | 5.00 ml | 6.70 ml |
| Start Wt | 12.23 g | 12.28 g | 12.23 g |
| End Wt | 12.07 g | 12.22 g | 12.18 g |
| Delta Wt | 0.16 g | 0.06 g | 0.05 g |
| wt % | 1.31% | 0.49% | 0.41% |
| Metal Loss | 0.015 lbm/ft2 | 0.006 lbm/ft2 | 0.005 lbm/ft2 |

The data clearly demonstrates the higher iodide concentration increases the corrosion inhibition of the Gemini 1.95:1 thereby allowing for reduced concentrations while providing corrosion inhibition well below the accepted 0.05 lbm/ft₂.

Another series of corrosion test were conducted on P110 coupons at 250° F., 3000 psig for 12 hours at temperature. The inhibited acid comprised 15 wt % HCl with

15 gpt Gemini 1.95:1 and 1300 ppm KI.

| Coupon | Initial (g) | Final (g) | Weight loss lb/ft2 | Pitting |
|---|---|---|---|---|
| 10 | 12.7370 | 12.6259 | 0.0115 | none |
| 1 | 13.3253 | 13.2127 | 0.0117 | none |

### Synthesis of Oligomers of Polycyclic Diquaternary Quinoxaline

To a 250 ml round bottom flask mounted on a magnetic stirrer with stirring rod, 20 ml of EB Solvent was added followed by 1 ml of 90% Formic acid and 20 ml of Gemini 1.95:1 (approximately 44.5% active). While stirring, and solution comprising 30 ml R.O. water and 6 g KNO₂ was slowly dripped into the stirring solutions over a period of 20 minutes. The combined mixture was allowed to react overnight resulting in the black solution comprising oligomers of polycyclic diquaternary quinoxaline.

Synthesis of Polycyclic Diquaternary Quinoxaline with Benzyl Iodide

To a round bottom flask mounted on a magnetic stirrer, 65 ml acetone, 65 ml benzyl chloride and 84.67 g sodium iodide crystals were added and mixed for approximately 30 minutes. A thick slurry developed along with a noticeable exotherm. The slurry was diluted with 150 ml of RO water and mixed to dissolve the salt (NaCl). After mixing, the solution was added to a separating funnel and allowed to rest for approximately 5 minutes. After the dark benzyl iodide separated from the aqueous phase to the bottom of the funnel, the benzyl iodide was collected. Approximately 75 ml was recovered.

A ceramic dish containing water and a layer of silicone oil was placed on a stirring hot plate. A 420 ml glass pressure vessel was placed into the water bath and secured. A stirring rod was inserted and 150 ml of methanol was added followed by 30.0 g of O-phenylenediamine. While mixing 21.75 ml of 40% glyoxal was added. The solution turned amber in color as the diamine dissolved producing the quinoxaline solution. The solution was allowed to stir and react for 15 minutes, then 75 ml of the recovered benzyl iodide was added. The pressure vessel was sealed and the hot plate was set to 300° C. which brought the temperature of the water bath to 60° C. The hot plate temperature was then set to 120° C. allowing the temperature reach equilibrium at 74° C. The solution was allowed to react at temperature for about 20 hrs, then the heat was turned off allowing the blue-black solution to mix and cool.

### Limestone Digestion

Samples of various acidizing compositions were heated in a water bath to 66° C. (150° F.). Sample volumes comprised 185 ml of 15 wt % HCl into which the other additives were added. Indiana limestone samples were obtained and cut from a slab to obtain samples of approximately the same geometry and weight. A Nalgene sample bottle containing the heated sample to be tested was weighed then zeroed. The pre-weighed limestone sample was dropped into the heated sample and time was monitored while recording the remaining weight of the limestone sample in 1-minute increments. The accumulated weight loss was plotted to compare the trajectory of the slopes over time.

The results illustrate the slope of the inhibited acidizing solutions can be altered to either increase or decrease the rate of limestone digestion while the Control showed a rapid initial dissolution rate followed by a declining slope. The inhibited acids demonstrated a more methodical dissolution rate with the OCP demonstrating a near linear slope.

### Synthesis of Polycyclic Diquaternary Quinoxaline

A ceramic dish containing water and a layer of silicone oil was placed on a stirring hot plate. A 420 ml glass pressure vessel was placed into the water bath and secured. A stirring rod was inserted and 100 ml of methanol was added followed by 35.2 g quinoxaline. While mixing 68.5 ml (~75.32 g) benzyl chloride was added. The pressure vessel was sealed and the water bath was heated to 70-75° C. while mixing for approximately 20 hours. After cooling, 40 g of EB solvent was added followed by 20.72 g Stepfac TSP PE K supplied by Stepan chemical company. The sample was added and mixed for approximately 2 hours. The recovered solution was designated Phalanx V. A 25 g sample of 4-Acetoxystyrene was purchased from Sigma Aldrich. The 4-Acetoxystyrene was mixed with 22.5 g EB solvent and 2.5 g Stepfac 8180 for approximately 1 hour. The sample was labeled Conditioner II

### Testing the Phalanx V and Conditioner II

The prepared samples we tested on multiple steel coupons at 250 F for 12 hours at 3000 psig. The acidizing solutions were prepared using 15 wt % HCl and blending in 5 gpt Phalanx V, 5 gpt Conditioner II and 500 ppm KI. As noted in one of the repeated test, 20 gpt formic acid was added to enhance the performance on the N-80 steel coupon.

| 250 F. | 12 hr | 3000 psig | | | |
|---|---|---|---|---|---|
| Metal | Initial | Final | Weight loss | lb/ft² | Pitting |
| P-110 | 13.3562 | 13.2104 | 0.1458 | 0.0132 | none |
| P-110 | 13.3163 | 13.1708 | 0.1455 | 0.0132 | none |
| N-80 | 30.4425 | 29.9243 | 0.5182 | 0.0362 | none |
| N-80 | 30.5679 | 30.3782 | 0.1897 | 0.0132* | none |
| 316SS | 48.0687 | 48.0208 | 0.0479 | 0.0034 | none |

*Formic Acid added

The results of the coupons testing are extremely impressive especially as it pertains to the 316SS coupon, as stainless steel is notoriously prone to pitting corrosion in 15% HCl.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

1. An acid composition for acidizing a wellbore, the composition comprising:
at least one acid;
an effective amount of an acetoxystyrene;
an effective amount of polycyclic diquaternary quinoxaline;
the polycyclic diquaternary quinoxaline having the general structure: 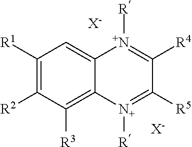
where X⁻ comprises a counter anion,
R′ comprises an alkyl aryl group, and
R¹, R², R³, R⁴ and R⁵ comprise hydrogen or a substitution group;
the acetoxystyrene having the general structure: 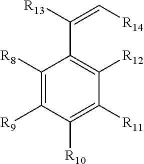
wherein R₈, R₁₀, and R₁₂ are H, O(C═O)CH₃, or OCH₃;
R₉ and R₁₁ are H, OH, OCH₃ or linear or branched alkyl;
R₁₃ and R₁₄ are H, halo, or cyan; and
provided that at least one of R₈, R₁₀ or R₁₂ is O(C═O)CH₃.

2. The acid composition according to claim 1, wherein the alkyl aryl group is selected from at least one of benzyl, benzoyl, vinylbenzyl and methyl naphthalene.

3. The acid composition according to claim 1, wherein R¹, R², R³, R⁴ and R⁵ comprise substitution groups selected from: halo, alkyl, aryl and alkyl aryl.

4. The acid composition according to claim 1, wherein the acid composition comprises from about 0.5 parts by weight to about 5.0 parts by weight of the polycyclic diquaternary quinoxaline for every about 1.0 part by weight of the acetoxystyrene.

5. The acid composition according to claim 1, wherein the acetoxystyrene is 4-acetoxystyrene.

6. The acid composition according to claim 1, wherein the acid composition comprises from about 0.5 parts by weight to about 2.0 parts by weight of the polycyclic diquaternary quinoxaline for every about 1.0 part by weight of the acetoxystyrene.

7. The acid composition according to claim 1, wherein the counter anion comprises at least one of a chloride, bromide and iodide.

8. The acid composition according to claim 1, further comprising an intensifier selected from at least one of an iodide donor, an aldehyde and formic acid.

9. The method according to claim 1, wherein the corrosion inhibitor composition inhibits corrosion of zinc, copper, aluminum, nickel, chromium, iron alloys thereof, or a combination thereof, in the presence of an acid.

10. The acid composition according to claim 1, wherein the polycyclic diquaternary quinoxaline comprises dibenzyl diquaternary quinoxaline having the general structure: 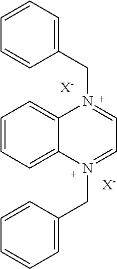
wherein X⁻ comprises a counter anion.

11. The acid composition according to claim 1, further comprising at least one of a surfactant and hydrotrope.

12. The acid composition according to claim 1, wherein the acid comprises about 15 wt % HCl.

13. The acid composition according to claim 1, wherein the acid comprises a synthetic acid.

14. The acid composition according to claim 1, wherein the acid comprises a mineral acid selected from at least one of hydrochloric acid, hydrofluoric acid, sulfuric acid and nitric acid.

15. The acid composition according to claim 1, wherein the acid comprises an amount ranging from about 5 to 28 wt %.

16. The acid composition according to claim 1, wherein the composition is diluted with water at the point-of-use to achieve a ratio of composition and water of 1:1 respectively.

17. The acid composition according to claim 1, wherein the composition is diluted with water at the point-of-use to achieve a ratio of composition and water of 1:2 respectively.

18. A method of forming a hydrocarbon-bearing formation for a stimulation operation, the method comprising the steps:
assessing at least a first location and a second location for perforation of a casing in a wellbore;
inserting a bottom hole assembly into the wellbore;
the bottom hole assembly comprising a plug and a perforation tool and the bottom hole assembly being connected to a wireline;
injecting an acidic composition into the wellbore;
wherein the acidic composition is indirect contact with the perforation tool, the wireline and the casing;
positioning and setting the plug in the wellbore at a position downhole but proximate to the first location;
positioning the perforation tool at the first location;
perforating the casing at the first location with the perforation tool thereby creating a first perforated area and a first cementitious debris;
allowing the acidic composition to come into contact with the first perforated area and the first cementitious debris for a predetermined period of time to prepare the formation for the stimulation operation;
moving the perforation tool up-hole to the second location;
perforating the casing at the second location with the perforation tool thereby creating a second perforated area and a second cementitious debris;
allowing the acidic composition to come into contact with the second perforated area and the second cementitious debris for a predetermined period of time to prepare the formation for the stimulation operation;
removing the perforation tool from the wellbore:
wherein the acid composition comprises an acid and a corrosion inhibitor composition, the corrosion inhibitor composition comprising:
an effective amount of an acetoxystyrene, and
an effective amount of polycyclic diquaternary quinoxaline;
the polycyclic diquaternary quinoxaline having the general structure: 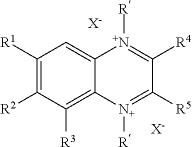
wherein X⁻ comprises a counter anion,
R′ comprises an alkyl aryl group, and
R¹, R², R³, R⁴ and R⁵ comprise hydrogen or a substitution group;
the acetoxystyrene having the general structure: 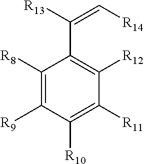
wherein R₈, R₁₀, and R₁₂ are H, O(C═O)CH₃, or OCH₃;
R₉ and R₁₁ are H, OH, OCH₃ or linear or branched alkyl;
R₁₃ and R₁₄ are H, halo, or cyan; and
provided that at least one of R₈, R₁₀ or R₁₂ is O(C═O)CH₃.

19. The method according to claim 18, wherein the corrosion inhibitor composition inhibits corrosion of zinc, copper, aluminum, nickel, chromium, iron alloys thereof, or a combination thereof, in the presence of an acid.

20. The method according to claim 18, wherein the corrosion inhibitor composition inhibits corrosion of at least one of the wellbore, wireline and perforating tool.

21. The method according to claim 18, wherein the alkyl aryl group is selected from at least one of benzyl, benzoyl, vinylbenzyl and methyl naphthalene.

22. The method according to claim 18, wherein R¹, R², R³, R⁴ and R⁵ comprise substitution groups selected from: halo, alkyl, aryl and alkyl aryl.

23. The method according to claim 18, wherein the counter anion comprises at least one of a chloride, bromide and iodide.

24. The method according to claim 18, further comprising an intensifier selected from at least one of an iodide donor, an aldehyde and formic acid.

25. The method according to claim 18, wherein the acetoxystyrene is 4-acetoxystyrene.

26. The method according to claim 18, wherein the polycyclic diquaternary quinoxaline comprises dibenzyl diquaternary quinoxaline having the general structure: 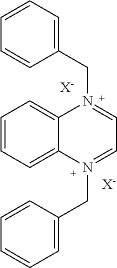
wherein X⁻ comprises at least one of chloride, bromide and iodide.

27. The method according to claim 18, further comprising at least one of a hydrotrope and surfactant.

28. The acid composition according to claim 18, wherein the acid composition comprises from about 0.5 parts by weight to about 5.0 parts by weight of the polycyclic diquaternary quinoxaline for every about 1.0 part by weight of the acetoxystyrene.

29. The acid composition according to claim 18, wherein the acid composition comprises from about 0.5 parts by weight to about 2.0 parts by weight of the polycyclic diquaternary quinoxaline for every about 1.0 part by weight of the acetoxystyrene.

30. The acid composition according to claim 18, wherein the inhibited acid composition is compatible with stainless steel tankers for transporting the inhibited acid composition.

31. An acid composition for acidizing a wellbore, the composition comprising:
at least one acid;
an effective amount of an acetoxystyrene;
an effective amount of quaternary quinoline;
the quaternary quinoline having the general structure: 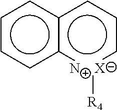
where X⁻ comprises a halide counter anion,
R₄ comprises an unsubstituted or an inertly substituted alkyl having 4 carbon atoms to 16 carbon atoms, or an unsubstituted or inertly substituted alkyl aryl having 7 carbon atoms to 20 carbon atoms;
the acetoxystyrene having the general structure: 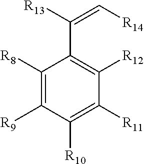
wherein R₈, R₁₀, and R₁₂ are H, O(C═O)CH₃, or OCH₃;
R₉ and R₁₁ are H, OH, OCH₃ or linear or branched alkyl;
R₁₃ and R₁₄ are H, halo, or cyan; and
provided that at least one of R₈, R₁₀ or R₁₂ is O(C═O)CH₃.

32. The acid composition according to claim 31, wherein the counter anion comprises at least one of a chloride, bromide and iodide.

33. The acid composition according to claim 31, further comprising an intensifier selected from at least one of an iodide donor, an aldehyde and formic acid.

34. The method according to claim 31, wherein the corrosion inhibitor composition inhibits corrosion of zinc, copper, aluminum, nickel, chromium, iron alloys thereof, or a combination thereof, in the presence of an acid.

35. The method according to claim 31, wherein the acetoxystyrene is 4-acetoxystyrene.

36. The method according to claim 31, further comprising at least one of a hydrotrope and surfactant.

37. A method of forming a hydrocarbon-bearing formation for a stimulation operation, the method comprising the steps:
assessing at least a first location and a second location for perforation of a casing in a wellbore;
inserting a bottom hole assembly into the wellbore;
the bottom hole assembly comprising a plug and a perforation tool and the bottom hole assembly being connected to a wireline;
injecting an acidic composition into the wellbore;
wherein the acidic composition is indirect contact with the perforation tool, the wireline and the casing;
positioning and setting the plug in the wellbore at a position downhole but proximate to the first location;
positioning the perforation tool at the first location;
perforating the casing at the first location with the perforation tool thereby creating a first perforated area and a first cementitious debris;
allowing the acidic composition to come into contact with the first perforated area and the first cementitious debris for a predetermined period of time to prepare the formation for the stimulation operation;
moving the perforation tool up-hole to the second location;
perforating the casing at the second location with the perforation tool thereby creating a second perforated area and a second cementitious debris;
allowing the acidic composition to come into contact with the second perforated area and the second cementitious debris for a predetermined period of time to prepare the formation for the stimulation operation;
removing the perforation tool from the wellbore:
wherein the acid composition comprises an acid and a corrosion inhibitor composition, the corrosion inhibitor composition comprising:
an effective amount of an acetoxystyrene, and
an effective amount of quaternary quinoline;
the quaternary quinoline having the general structure: 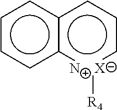
where X⁻ comprises a halide counter anion,
R₄ comprises an unsubstituted or an inertly substituted alkyl having 4 carbon atoms to 16 carbon atoms, or an unsubstituted or inertly substituted alkyl aryl having 7 carbon atoms to 20 carbon atoms;
the acetoxystyrene having the general structure: 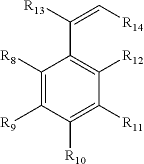
wherein R₈, R₁₀, and R₁₂ are H, O(C═O)CH₃, or OCH₃;
R₉ and R₁₁ are H, OH, OCH₃ or linear or branched alkyl;
R₁₃ and R₁₄ are H, halo, or cyan; and
provided that at least one of R₈, R₁₀ or R₁₂ is O(C═O)CH₃.

38. The method according to claim 37, wherein the corrosion inhibitor composition inhibits corrosion of zinc, copper, aluminum, nickel, chromium, iron alloys thereof, or a combination thereof, in the presence of an acid.

39. The method according to claim 37, wherein the corrosion inhibitor composition inhibits corrosion of at least one of the wellbore, wireline and perforating tool.

40. The method according to claim 37, wherein the counter anion comprises at least one of a chloride, bromide and iodide.

41. The method according to claim 37, wherein the acetoxystyrene is 4-acetoxystyrene.

42. The method according to claim 37, further comprising an intensifier selected from at least one of an iodide donor, an aldehyde and formic acid.

43. The method according to claim 37, further comprising at least one of a hydrotrope and surfactant.
